(19) United States
(12) Patent Application Publication
(10) Pub. No.: US 2004/0101628 A1
(43) Pub. Date: May 27, 2004

(54) Non-spray invisible small area repair technique

(76) Inventors: John R. Schneider, Glenshaw, PA (US); David N. Walters, Slippery Rock, PA (US); Robert E. Jennings, Ellwood City, PA (US); James A. Claar, Apollo, PA (US)

Correspondence Address: PPG INDUSTRIES, INC., Intellectual Property Department, One PPG Place, Pittsburgh, PA, 15272, US

(21) Appl. No.: 10/305,082

(22) Filed: Nov. 26, 2002

(51) Int. Cl. B05D 1/36

(52) U.S. Cl. 427/407.1

(57) ABSTRACT

A method for refinishing an area of an automobile's exterior is disclosed. The method comprises the following the steps: sanding the area of the automobile's exterior which is to be refinished; cleaning the sanded area; applying a layer of primer formed from a liquid primer or a pre-formed sheet of primer to the cleaned area; applying a layer of basecoat formed from a liquid basecoat or a pre-formed sheet of basecoat over the layer of primer; applying a layer of clearcoat formed from a liquid clearcoat or a pre-formed sheet of clearcoat over the layer of basecoat; and sanding and buffing the layer of clearcoat.

### FIELD OF THE INVENTION

The present invention relates to methods for refinishing a portion of an automobile's exterior coating.

### BACKGROUND OF THE INVENTION

An automobile's exterior coating comprises several discreet coating layers. Over time, the automobile's exterior coating becomes chipped and/or scratched for various reasons.

When an automobile's exterior coating is chipped and/or scratched to such a degree that the appearance of the automobile is adversely affected, the damaged area should be “refinished”. In the automotive repair industry, the term “refinish” describes the process whereby an automobile's exterior coating receives one or more new coating layer(s).

Refinishing a portion of an automobile's exterior coating essentially entails removing the original layers of coating and replacing them with new layers of coating. A variety of different methods and products are utilized in body shops throughout the world to refinish automotive exteriors. All of the different methods and products used have one objective—a good, efficient, and cost effective repair for the customer. For a repair to be good, the color and overall appearance of the repair must match, in the eyes of the customer, the color and overall appearance of the original coating in adjacent areas.

Conventional refinish methods utilize liquid coating compositions to form the various coating layers. Liquid compositions are costly and complex.

The present invention provides an improved method for refinishing at least a portion of an automobile's exterior coating by utilizing pre-formed sheets of coating and/or liquid compositions to form the various coating layers.

### SUMMARY OF THE INVENTION

The present invention is method of refinishing at least a portion of an automobile's exterior coating layers comprising the steps of:

a. sanding the area of the automobile's exterior which is to be refinished;

b. cleaning the sanded area;

c. applying a layer of primer formed from a pre-formed sheet of primer to the cleaned area;

d. applying a layer of basecoat formed from a pre-formed sheet of basecoat over the layer of primer;

e. applying a layer of clearcoat formed from a pre-formed sheet of clearcoat over the layer of basecoat; and

f. sanding and buffing the layer of clearcoat.

In another embodiment, the present invention is a method for refinishing an area of an automobile's exterior comprising the steps of:

a. sanding the area of the automobile's exterior which is to be refinished;

b. cleaning the sanded area;

c. applying a layer of primer formed from a pre-formed sheet of primer to the cleaned area;

d. applying a layer of liquid basecoat over the layer of primer;

e. drying or curing the layer of basecoat;

f. applying a layer of liquid clearcoat over the layer of cured basecoat; and

g. curing the layer of clearcoat.

In yet another embodiment, the present invention is a method for refinishing an area of an automobile's exterior comprising the steps of:

a. sanding the area of the automobile's exterior which is to be refinished;

b. cleaning the sanded area;

c. applying a layer of liquid primer to the cleaned area;

d. applying a layer of basecoat formed from a pre-formed sheet of basecoat over the layer of primer;

e. applying a layer of liquid clearcoat over the layer of basecoat; and

f. curing the layer of clearcoat.

In another embodiment, the present invention is a method for refinishing an area of an automobile's exterior comprising the steps of:

a. sanding the area of the automobile's exterior which is to be refinished;

b. cleaning the sanded area;

c. applying a layer of liquid primer to the cleaned area;

d. applying a layer of liquid basecoat over the layer of primer;

e. curing the layer of basecoat;

f. applying a layer of clearcoat formed from a pre-formed sheet of clearcoat over the layer of basecoat; and

g. sanding and buffing the layer of clearcoat.

In a further embodiment, the present invention is a method for refinishing an area of an automobile's exterior comprising the steps of:

a. sanding the area of the automobile's exterior which is to be refinished;

b. cleaning the sanded area;

c. applying a layer of direct gloss basecoat formed from a pre-formed sheet of basecoat over the layer of primer.

### BRIEF DESCRIPTION OF THE DRAWINGS

FIG. 1 is a method of refinishing at least a portion of an automobile's exterior coating according to the present invention.

### DETAILED DESCRIPTION OF THE INVENTION

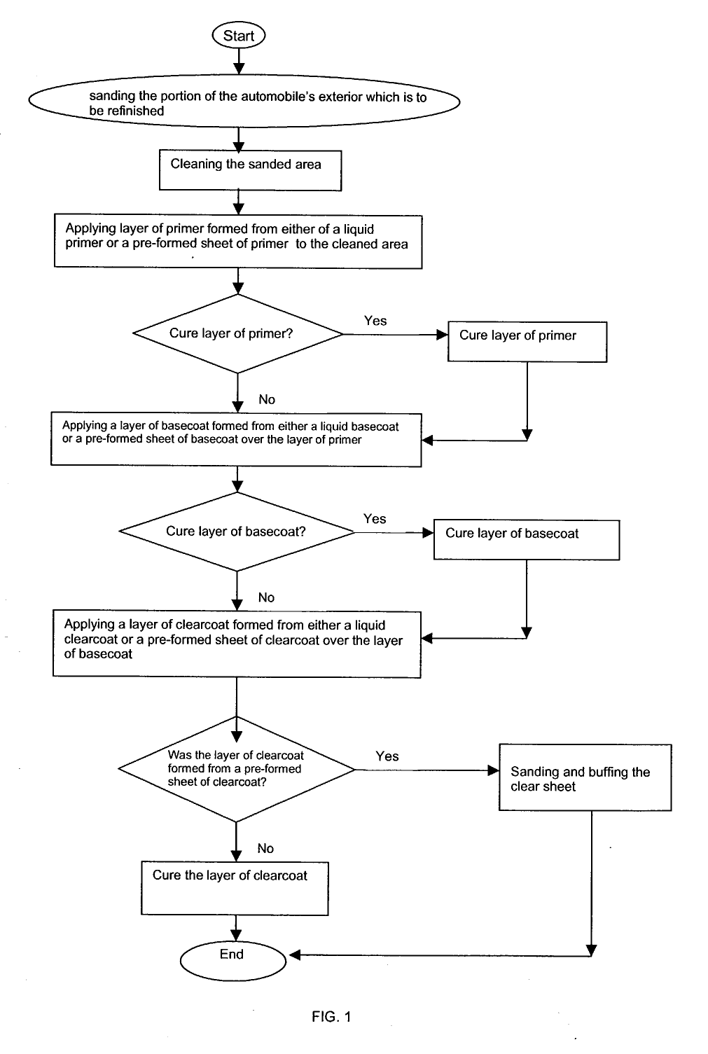

The present invention is a method of refinishing at least a portion of an automobile's exterior coating. As shown in FIG. 1, the method of the present invention comprises the following steps.

The first step in the present invention comprises sanding the portion of the automobile's exterior surface which is to be refinished with abrasive paste or sandpaper using conventional refinish sanding techniques. Polishing compound is a suitable abrasive paste. Various grades of sandpaper can be used including wet, 600 grit sand paper.

The second step of the present invention comprises cleaning the sanded portion of the automobile's exterior surface. The entire area, including any recesses, should be cleaned. Cleaning can be accomplished using a soft cloth containing a conventional degrease/cleaner. Suitable degreasers/cleaners include silicone stripper and DX330 which is commercially available from PPG Industries, Inc.

In one embodiment of the present invention, the third step of the invention comprises applying a layer of primer over the portion of the automobile's exterior surface which has been sanded and cleaned. The primer can be can be a liquid composition or a pre-formed sheet.

If a liquid primer is utilized in the present invention, conventional liquid primers as are well known in the art can be used. Suitable liquid primers include lacquer primers and 2K primers comprising an acrylic polyol and a polyisocyanate crosslinker. Other nonlimiting examples of liquid primers are disclosed in U.S. Pat. No. 4,971,837, U.S. Pat. No. 5,492,731, and U.S. Pat. No. 5,262,464 which are hereby incorporated by reference.

The liquid primer can be applied using conventional techniques. For example, the liquid primer can be applied via aerosol coating, spray coating, brush coating, and combinations thereof.

Depending on the type of coating system, i.e. wet-on-wet system or dry-on-wet system, the liquid primer may or may not be cured. The term “cured” encompasses simple drying operations as well as curing via a chemical reaction.

In a dry-on-wet system, the liquid primer is cured. Thermal or ambient means can be used to cure the primer.

In a wet-on-wet system, the liquid primer is not cured. However, the primer can be given a solvent flash to remove solvent.

Ultimately, the dry film thickness of the layer of primer should range between 0.5 mils to 6 mils or 1.5 mils to 4 mils.

If a pre-formed sheet of primer is utilized in the present invention, the pre-formed sheet can be formed in the following manner. Suitable primer compositions as described above are sprayed onto a suitable release backing. Generally, the primer composition is sprayed so that the film build thickness of the primer ranges from between 0.05 mils to 6 mils or 0.5 mils to 4 mils. The primer composition can be sprayed in such a manner that the thickness of the primer is greatest at the center of the release backing and gradually thins out towards the edges of the release backing. Suitable release backings include Tedlar™ which is commercially available from Dupont. After the primer is sprayed onto the release backing, the primer is cured via ambient or thermal means.

The pre-formed sheet of primer can be applied directly on to the sanded and cleaned area or it can be applied over a layer of adhesive. The adhesive can be a waterbased adhesive, a solvent based adhesive, a UV based adhesive, or a two pack adhesive. Suitable waterbased adhesives are disclosed in U.S. Pat. No. 5,652,299 which is hereby incorporated by reference. Suitable solvent based adhesives includes DSX1900 Bonding Clear which is commercially available from PPG Industries, Inc. Suitable UV based adhesives include Speedprime DS-880 which is commercially available from PPG Industries, Inc. An example of a suitable two pack adhesive is DTM which is commercially available from PPG Industries, Inc.

The adhesive can be applied via sprayer, eye dropper, rollers, brushes, etc. The dry film thickness of the adhesive can be between 0.001 mils to 0.25 mils or 0.001 mils to 0.05 mils.

If the pre-formed sheet of primer is applied over a layer of adhesive, excessive adhesive and bubbles should be worked out from underneath the sheet until there are no bubbles or excess material. Towels and a Teflon knife can be used to remove excess adhesive and bubbles from underneath the sheet. After excess adhesive and bubbles have been removed from underneath the sheet, the adhesive is either cured or dried depending on the type of adhesive used. The curing or drying times can range from between 2 minutes to 30 minutes. Upon completion of the curing or drying step, the release backing can be removed.

In one embodiment of the invention, as shown in FIG. 1, the next step of the present invention comprises applying a layer of basecoat over the layer of primer. The basecoat can be a liquid composition or a pre-formed sheet. The color of the basecoat should match the color of the original finish in adjacent areas.

If the basecoat is a liquid composition, conventional liquid basecoat compositions which are well known in the art can be utilized. For example, the liquid basecoat can be a lacquer or it can comprise one or more crosslinkable film-forming resins and one or more crosslinking agents capable of reacting with the film-forming resins to form a crosslinked film.

When the liquid basecoat is a lacquer, Suitable lacquers can be derived from thermoplastic resins. Suitable thermoplastic resins include polyvinylchloride resins, nonreactive acrylic resins, nonreactive vinyl resins, and mixtures of the aforementioned resins.

When the liquid basecoat comprises one or more crosslinkable film-forming resins and one or more crosslinking agents capable of reacting with the film-forming resins to form a crosslinked film, suitable crosslinkable film-forming resins include active hydrogen containing polymers such as polyesters, alkyds, polyurethanes, acrylic polymers, and polyethers. Polyamines and epoxy-containing polymers are also suitable crosslinkable film-forming resins. Suitable crosslinking agents are aminoplasts, blocked or unblocked polyisocyanates, polyacids, anhydrides and mixtures thereof. The choice of a crosslinking agent is determined by the reactive functional groups on the film-forming resin.

Optionally, the basecoat composition can contain additives like pigments, ultraviolet absorbers, rheology control agents, surfactants, etc. Examples of suitable pigments are iron oxides, carbon black, titanium dioxide, phthalocyanines, mica flakes, aluminum flakes, copper flakes, etc. If pigments are present in the basecoat composition, the pigment weight concentration (the weight of pigment divided by total resin solids in the basecoat composition plus pigment) should be approximately 2 percent.

The liquid basecoat composition can be applied using conventional means as are well known in the art. For example, the liquid basecoat composition can be applied over the layer of primer via spray guns such as HVLP guns and normal pneumatic, high-performance spray guns.

After the liquid basecoat is applied, it must be cured. The liquid basecoat composition can be cured via thermal or ambient means which are well known in the art. If the liquid basecoat composition is a lacquer, it is typically cured by exposure to air. Upon exposure to air, any solvent or diluent evaporates. The dry film thickness of the layer of basecoat can range from between 0.2 mils to 2 mils or 0.5 mils to 1.5 mils.

If a pre-formed sheet of basecoat is utilized in the present invention, the pre-formed sheet can be formed in the following manner. Suitable basecoat compositions as described above are sprayed onto a suitable release backing. Generally, the basecoat composition is sprayed so that the film build thickness of the basecoat ranges from between ranges from between 0.05 mils to 6 mils or 0.5 mils to 4 mils. Suitable release backings include Tedlar™ which is commercially available from Dupont. After the basecoat is sprayed onto the release backing, the basecoat is cured via ambient or thermal means.

The sheet of basecoat can be applied directly over the layer of primer or it can be applied over a layer of adhesive. The adhesive can be a waterbased adhesive, a solvent based adhesive, or a two pack adhesive. The adhesive can be applied via sprayer, eye dropper, rollers, brushes, etc. The dry film thickness of the adhesive can be between 0.001 mils to 0.25 mils or 0.001 mils to 0.05 mils.

If the pre-formed sheet of basecoat is applied over a layer of adhesive, excess adhesive and bubbles should be worked out from underneath the sheet until no material exist. Towels and a Teflon knife can be used to remove excessive adhesive and bubbles from underneath the sheet. After the pre-formed sheet of basecoat has been on the adhesive for a period of time sufficient for the adhesive to cure or dry, typically about 30 minutes, the release backing can be removed.

In an alternative embodiment of the invention which is not shown in FIG. 1, the pre-formed sheet of direct gloss basecoat can be applied directly to a sanded and cleaned substrate or over a layer of primer. In this embodiment, the sheet of basecoat will be applied as a “direct gloss system” whereby a single coating layer is applied to a substrate rather than multiple coating layers.

In the embodiment of the invention shown in FIG. 1, the next step in the invention comprises applying a layer of clearcoat over the layer of basecoat. The clearcoat can be a liquid composition or a pre-formed sheet of clearcoat.

If the layer of clearcoat is a liquid composition, conventional liquid clearcoat compositions as are well known in the art can be utilized. For example, the clearcoat composition can be formed by mixing a crosslinkable film-forming resin with one or more crosslinking materials capable of reacting with the film-forming resin to form a crosslinked film.

Suitable crosslinkable film-forming resins include polyesters, polyurethanes, acrylic polymers, polyamides, polyethers and mixtures thereof. The film-forming resins used must be sandable and buffable. The number average molecular weight and the weight average molecular weight of the resins must be high enough to form a continuous film. The glass transition temperature (Tg) of the resins must be above room temperature.

Suitable crosslinking materials include those mentioned above for the basecoat.

Suitable clearcoat compositions are disclosed in U.S. Pat. No. 5,098,947, U.S. Pat. No. 5,196,485, and U.S. Pat. No. 5,814,410 which are hereby incorporated by reference.

The liquid clearcoat composition can be applied using conventional means as are well known in the art. For example, the liquid clearcoat composition can be applied over the layer of basecoat via spray guns such as HVLP guns and normal pneumatic, high-performance spray guns.

After the liquid clearcoat is applied, it must be cured. The liquid clearcoat can be cured via means which are well known in the art. The liquid clearcoat can be cured via baking in an oven at 62 degrees C. for approximately 1 hour. The dry film thickness of the layer of clearcoat can range from between 1.5 mils to 5 mils or 2.0 mils to 3.5 mils.

If a pre-formed sheet of clearcoat is utilized in the present invention, the pre-formed sheet can be formed in the following manner. Suitable clearcoat compositions as described above are sprayed onto a suitable release backing. Generally, the clearcoat composition is sprayed so that the film build thickness of the clearcoat ranges from between ranges from between 0.01 mils to 1.5 mils or 0.1 mils to 1.2 mils. The clearcoat composition can be sprayed in such a manner that the film build thickness of the clearcoat is greatest at the center of the release backing and gradually thins out toward the edges of the backing. Suitable release backings include Tedlar™ which is commercially available from Dupont. After the clearcoat is sprayed onto the release backing, the clearcoat is cured via ambient or thermal means. The composition can be cured via baking in an oven at 62 degrees C. for approximately 1 hour.

The sheet of clearcoat can be applied directly over the layer of basecoat or it can be applied over a layer of adhesive. The adhesive can be a waterbased adhesive, a solvent based adhesive, a UV based adhesive, or a two pack adhesive. Examples of the various types of adhesives are included above in the discussion concerning the layer of primer. The adhesive can be applied via sprayer, eye dropper, rollers, brushes, etc. The dry film thickness of the adhesive should be between 0.001 mils to 0.25 mils to 0.001 to 0.05.

If the pre-formed sheet of clearcoat is applied on the layer of adhesive during the refinish operation, excessive adhesive and bubbles can be removed from underneath the sheet until there are no bubbles nor excess material. Towels and a Teflon knife can be used to work excessive adhesive and bubbles from underneath the sheet. After the adhesive cures or dries, the release backing can be removed.

As shown in FIG. 1, the last step of one embodiment of the present invention comprises sanding and buffing the layer of clearcoat so the portion of the automobile's exterior that has been refinished blends in with adjacent areas containing that contain the original finish. Conventional refinish sanding and buffing techniques as are well known in the art are utilized. The sheet of clearcoat can be dual action sanded with 500 grit sand paper and sanded by hand with 1500 grit sand paper. The sheet of clearcoat can be buffed with a buffer using a buffing compound and polished with a polishing compound. The dry film thickness of the layer of clearcoat can range from between 1.5 mils to 5 mils or 2.0 mils to 3.5 mils. In the end, a customer should not be able to perceive any difference between the refinished area and areas adjacent to it.

The method of the present invention can be used to refinish automotive exteriors made from various substrates including metal and plastic. The method of the present invention is vastly more efficient and more cost effective than conventional refinish methods.

### EXAMPLES

The present invention will be further illustrated by the non-limiting examples below. An exemplary liquid primer composition is K36 Refinish Primer which is commercially available from PPG Industries, Inc. An exemplary liquid basecoat composition is PPG Global Basecoat which is available from PPG Industries, Inc. Table 1 contains formulation data for a suitable liquid clearcoat composition. Table 2 shows how a pre-formed sheet of coating is prepared by applying a liquid coating at various film builds on a release backing.

TABLE 1
Clearcoat Formulation Data
A suitable clearcoat composition is an acrylic/nitrocellulose lacquer
having low solids (approximately 10%). The clearcoat composition
can be prepared by mixing together the following components:

| Component | Grams |
|---|---|
| Nitrocellulose | 107.5 |
| Acrylic lacquer | 100.5 |
| Xylene | 200.0 |
| Methyl ethyl ketone | 200.0 |
| Plasticizer | 17.0 |
| Dowanol PM | 30.0 |

TABLE 2
The Formation of a Pre-formed Sheet of Coating
For exemplary purposes, the pre-formed sheet of coating was prepared
using a liquid primer composition. A liquid basecoat composition or a
liquid clearcoat composition could have been used.
A 4″ × 12″ pre-formed sheet of primer was formed as follows. K36
Refinish Primer was sprayed at 30 psi on to a 4″ × 12″ by 1 mil thick
Tedlar film. As seen in table below, the film build thickness of the
primer is greatest at the center of the release backing and gradually
thins out towards the edges of the backing. The primer was cured for
60 minutes at 60 degrees C.. The primer could have been cured
overnight at room temperature.

| Location on the Release Backing | Film Build (mils) |
|---|---|
| Middle 3 inches of the panel | 1.2 to 1.5 |
| 4 inches from the middle | 0.8 |
| 5 inches from the middle | 0.4 |
| 5.5 inches from the middle | 0.2 |
| Edge of the panel | 0.01 to 0.10 |

What is claimed:

1. A method for refinishing an area of an automobile's exterior coating comprising the steps of:
a. sanding the area of the automobile's exterior which is to be refinished;
b. cleaning the sanded area;
c. applying a layer of primer formed from a pre-formed sheet of primer to the cleaned area;
d. applying a layer of basecoat formed from a pre-formed sheet of basecoat over the layer of primer;
e. applying a layer of clearcoat formed from a pre-formed sheet of clearcoat over the layer of basecoat; and
f. sanding and buffing the layer of clearcoat.

2. The method according to claim 1 further comprising applying adhesive to the cleaned area before applying the pre-formed sheet of primer.

3. The method according to claim 1 further comprising applying adhesive to the layer of primer before applying the pre-formed sheet of basecoat.

4. The method according to claim 1 further comprising applying adhesive to the layer of basecoat before applying the pre-formed sheet of clearcoat.

5. The method according to claim 1 wherein the pre-formed clearcoat is formed by curing a clearcoat composition formed by mixing one or more crosslinkable film-forming resins and at least one crosslinking material capable of reacting with the film-forming resin to form a crosslinked film.

6. The method according to claim 5 wherein the film-forming resin is selected from the group consisting of polyesters, polyurethanes, acrylic polymers, polyamides, polyethers, epoxy group containing polymers, and mixtures thereof.

7. The method according to claim 5 wherein the crosslinking material is selected from the group consisting of aminoplasts, blocked or unblocked polyisocyanates, polyacids, anhydrides and mixtures thereof.

8. The method according to claim 2 wherein the layer of adhesive comprises a waterbased adhesive.

9. The method according to claim 2 wherein the layer of adhesive comprises a solvent based adhesive.

10. The method according to claim 2 wherein the layer of adhesive comprises a UV curable adhesive.

11. A method for refinishing an area of an automobile's exterior comprising the steps of:
a. sanding the area of the automobile's exterior which is to be refinished;
b. cleaning the sanded area;
c. applying a layer of primer formed from a pre-formed sheet of primer to the cleaned area;
d. applying a layer of liquid basecoat over the layer of primer;
e. curing the layer of basecoat;
f. applying a layer of clearcoat over the layer of cured basecoat; and
g. curing the layer of clearcoat.

12. The method according to claim 11 further comprising applying adhesive to the cleaned area before applying the pre-formed sheet of primer.

13. A method for refinishing an area of an automobile's exterior comprising the steps of:
a. sanding the area of the automobile's exterior which is to be refinished;
b. cleaning the sanded area;
c. applying a layer of liquid primer to the cleaned area;
d. applying a layer of basecoat formed for a pre-formed sheet of basecoat over the layer of primer;
e. applying a layer of liquid clearcoat over the layer of basecoat; and
f. curing the layer of clearcoat.

14. The method according to claim 13 further comprising applying adhesive to the layer of liquid primer before applying the pre-formed sheet of basecoat.

15. A method for refinishing an area of an automobile's exterior comprising the steps of:
a. sanding the area of the automobile's exterior which is to be refinished;
b. cleaning the sanded area;
c. applying a layer of liquid primer to the cleaned area;
d. applying a layer of basecoat over the layer of primer;
e. curing the layer of basecoat;
f. applying a layer of clearcoat formed from a pre-formed sheet of clearcoat over the layer of basecoat; and
g. sanding and buffing the layer of clearcoat.

16. The method according to claim 15 further comprising applying adhesive to the layer of basecoat before applying the pre-formed sheet of clearcoat.

17. A method for refinishing an area of an automobile's exterior coating comprising the steps of:
a. sanding the area of the automobile's exterior which is to be refinished;
b. cleaning the sanded area;
c. applying a layer of basecoat formed from a pre-formed sheet of basecoat to the cleaned area.
